(19) United States
(12) Patent Application Publication
(10) Pub. No.: US 2009/0012895 A1
(43) Pub. Date: Jan. 8, 2009

(54) SYSTEM AND METHOD FOR CREATING AND PROMOTING A CAUSE AND PROCESSING PAYMENTS FOR THE CAUSE BY UTILIZING SOCIAL NETWORKS

(76) Inventor: Kevin Raumean Mehrabi, Los Angeles, CA (US)

Correspondence Address: JAFARI LAW GROUP, P.C., 801 N. PARKCENTER DRIVE, SUITE 220, SANTA ANA, CA, 92705, US

(21) Appl. No.: 11/774,444

(22) Filed: Jul. 6, 2007

(51) Int. Cl. G06Q 99/00; G06Q 40/00

(52) U.S. Cl. 705/39; 705/1

(57) ABSTRACT

The invention is a system and method for system and method for creating and promoting a cause and processing payments for the cause by utilizing social networks, and in particular, a social network, for example, a highly interactive on-line community, where individuals, representatives, or organizations, may securely conduct fundraising activities, raise awareness, and promote events. By injecting an application that may be virally distributed in a highly interactive on-line community and linking application users to a specially designed website, individuals, representatives, or organizations, may securely conduct fundraising activities, raise awareness, and promote events to a greater audience, thus achieving higher efficiency in a developing virtual environment.

### COPYRIGHT & TRADEMARK NOTICE

A portion of the disclosure of this patent document contains material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and shall not be construed as descriptive or to limit the scope of this invention to material associated only with such marks.

### TECHNICAL FIELD OF THE INVENTION

This invention relates generally to a system and method for creating and promoting a subsection such as a cause and processing payments for that subsection within a social networking structure composed of multiple sections, and more specifically where each subsection is complemented with tools that allow for the promotion of the subsection within an external website, code permitting, and specifically on the Facebook™ platform.

### BACKGROUND OF THE INVENTION

Traditionally, parties interested in raising awareness for particular issues, whether for personal reasons or to address social concerns, have developed numerous strategies to achieve their goals.

One of these strategies include canvassing, or going door to door and raising awareness of issues by personally speaking to individuals—many times also gathering funds from interested individuals that desire to donate to such causes. Such strategies are inefficient however because going door to door can prove ineffective since many individuals are not perceptive to strangers coming to their homes. Furthermore, such strategies are undesirable and often perceived as an intrusion on an individual's privacy which raises security concerns both for the canvasser and the unsuspected solicited individual.

Other practices involve word of mouth, passing out fliers, or posting information regarding a particular cause or event in some medium, for example, the internet. However, these current practices of providing cause information on the internet require that individuals either become aware of that particular site via real world advertisements or prior first hand knowledge before visiting the site. This is inefficient and does not captivate a wide enough audience considering the relative potential. Furthermore, the absence of some personal connection may eventually cause disinterest in a particular visitor to a website.

Thus, there is a need in the art for a more personal, efficient manner in which to promote events, raise awareness and collect funds, and in particular, a social network, for example, a highly interactive on-line community, where individuals, representatives, or organizations, may securely conduct fundraising activities, raise awareness, receive payments, and promote events utilizing an application that may be virally distributed throughout the network.

### SUMMARY OF THE INVENTION

To minimize the limitations found in the prior art, and to minimize other limitations that will be apparent upon the reading of the specification, the present invention provides system and method for creating and promoting a cause and processing payments for the cause by utilizing social networks, for example a highly interactive on-line community.

The present invention comprises an application that may be posted on a server and may be made available to users to share with other users within a network. This application may direct users to a website where interested parties have posted their personal accounts or causes accounts, and where interested users may make payments or donations on such accounts.

A system for creating, promoting, and receiving donations for a cause, in accordance with the present invention includes a first server that employs a cause creation module for: generating a cause webpage for establishing a cause; receiving a request from a first user for the cause webpage; sending the cause webpage to the first user wherein the cause webpage includes an input object for receiving information regarding the cause; receiving cause information from the first user; adding the cause information to the cause webpage; and updating a cause directory to add a hyperlink to the cause webpage. In addition, the system also includes a cause promotion module for: establishing a user profile web page including a cause hyperlink related to the cause; receiving a request for the cause webpage from a user; sending the cause webpage to the user. Furthermore, a cause donation module for: creating a cause donation webpage including a payment input object for receiving payment for the cause; crediting a first account with a first portion of the payment; crediting a second account with a second portion of the payment. The system further includes a second server for: creating a profile with a link to the cause webpage; receiving a request for the cause webpage from a user receiving a hyperlink detection; redirecting the user to the cause webpage.

A method of creating a cause in accordance with the present invention, comprises, generating a webpage for establishing a cause, receiving a request from a user for the webpage, sending the webpage to the user, receiving the cause information from the user, adding the cause information to the webpage, and updating a cause directory to add the cause webpage, wherein the webpage includes an input object for receiving information regarding the cause.

A method of promoting a cause, in accordance with the present invention, comprises establishing a user profile webpage including a hyperlink pointing to a cause webpage related to the cause, detecting an activation of the hyperlink, and sending the cause webpage to the user in response to detecting the activation of the hyperlink.

A method of actively promoting a cause in accordance with the present invention comprises, receiving information identifying a cause webpage, receiving information related to an address of a target party, and sending the cause webpage information to the target party using the address information of the target party.

A method of searching for a cause, in accordance with the present invention includes the steps of creating a first webpage listing a plurality of causes, receiving a selection of at least one of the cause from a user, and sending a second webpage related to the selected cause to the user.

Another method for searching for a cause includes the steps of receiving one or more parameters related to one or more causes from a user, creating a webpage with listing of one or more causes based on the one or more parameters, sending the webpage to the user, receiving a request for a cause webpage related to a selected cause, and sending the cause webpage to the user.

A method of receiving a donation for a cause in accordance with the present invention includes creating a cause donation webpage including a payment input object, receiving a payment from a donor, crediting a first account with a first portion of the payment, and crediting a second account with a second portion of the payment.

Finally, a method of linking a plurality of members of an external user profile server to a cause server in accordance with the present invention includes creating a profile with a hyperlink to a cause webpage, receiving a request for the cause webpage from a user, sending the cause webpage to the user.

It is an objective of the present invention to create a payment application that may be virally distributed throughout a network, for example, a highly interactive on-line community.

It is another objective of the present invention to create a website where users may post information regarding personal or social issues, causes, or events and share that information within a network.

It is still another objective of the present invention to link user profiles to the website via the payment applications.

It is still another objective of the present invention to allow users to share the payment application and implement the application into user profiles.

It is still another object of the present invention to provide individuals, representatives, or organizations, a forum where they may securely conduct fundraising activities, raise awareness, and promote events, with greater efficiency.

These and other advantages and features of the present invention are described with specificity so as to make the present invention understandable to one of ordinary skill in the art

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 illustrates one embodiment of a system for virally distributing an application to raise funds, awareness, or organize events throughout a network, in accordance with one embodiment of the present invention.

FIG. 2 is a flow chart depicting a basic method for generating a webpage and creating a cause in accordance with practice of the present invention.

FIG. 3(a) is a flowchart depicting a passive method for promoting a cause, in accordance with practice of the present invention.

FIG. 3(b) is a flowchart depicting an active method for promoting a cause, in accordance with practice of one embodiment the present invention.

FIG. 4(a) is a flowchart depicting one basic method of generating a search for a cause, in accordance with practice of one embodiment of the present invention.

FIG. 4(b) is a flowchart depicting another basic method of generating a search for a cause, in accordance with another embodiment of the present invention.

FIG. 5 is a flow chart depicting one method of receiving and processing a payment or donation, in accordance with one embodiment of the present invention.

FIG. 6 illustrates a flow chart for a sign-up process in accordance with one embodiment of the present invention.

FIG. 7 is an organizational chart depicting the functionality and navigation of a user's profile, in a Facebook™ platform, for a payment application in accordance with one embodiment of the present invention.

FIG. 8 is an organizational chart depicting the functionality and navigation of a user's profile, in a Facebook™ platform, for a causes and fundraising application in accordance with another embodiment of the present invention.

FIG. 9 is an organizational chart for a website, accessible via a link from a profile in a Facebook™ platform, where users can search for causes, post their own causes or events, set-up and manage their accounts, and post donations, in accordance with an exemplary embodiment of the present invention.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

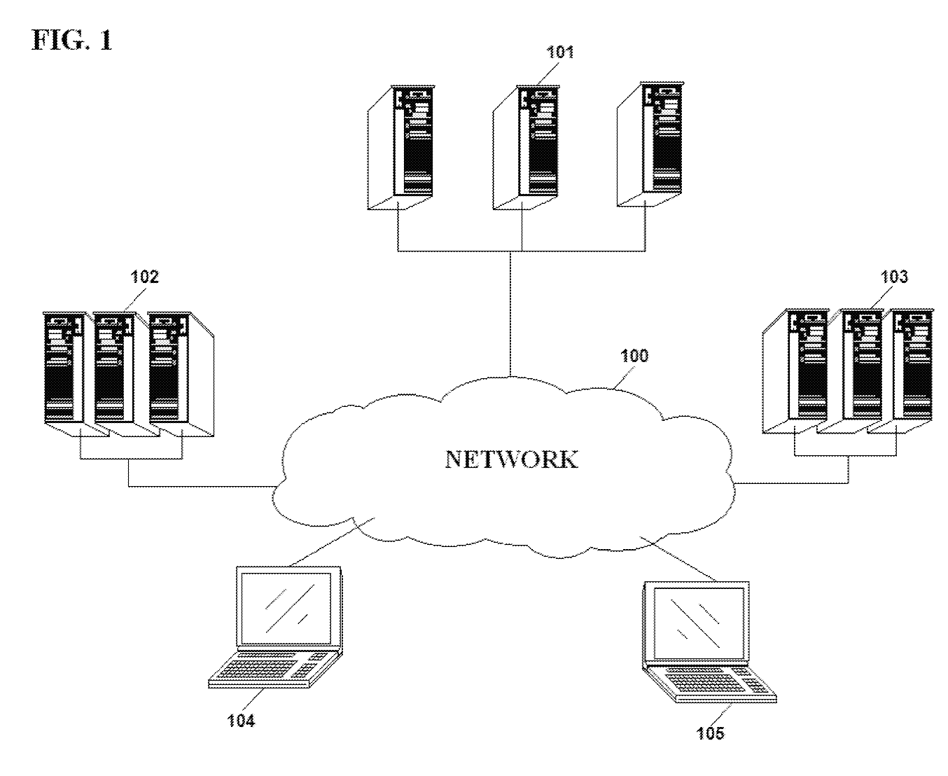

Turning first to FIG. 1, one embodiment of a system for virally distributing an application to raise funds, awareness, or organize events throughout a network, in accordance with one embodiment of the present invention, is illustrated. The system comprises servers 101, 102, and 103, network 100, user interface 104, and user interface 105.

Although shown here as three servers, servers 101, 102, and 103 may comprise a single server or multiple servers without departing from the scope of the present invention.

User interface 104 and user interface 105 may be accessed utilizing any type of computers capable of connecting to network 100. A connection with network 100 may be wireless, through a LAN connection, a dial-up connection, or any other method of connecting with network 100 without departing from the scope of the present invention.

Typically network 100 is a large network such as the World Wide Web, but network 100 may be any other type of network without departing from the scope of the present invention, for example a network composed of several computers within a university building.

In an exemplary embodiment of the present invention, server 101 is a profile server, such a Facebook™ platform, wherein profile information is stored for several users, each profile including a payment application or a causes and fundraisers application; server 102 hosts a website, for example, and without deviating from the scope of the present invention, built on a Linux platform using Apache 2.2.4, PHP 5.2.1, and MySQL 5.0 that allows users to create their own web pages to distribute information regarding personal issues, events, or causes for which they desire to generate awareness or raise funds; and server 103 is a donations/transactions server that controls and keeps track of the transactions from the various users donating or otherwise making payments—for example, and without deviating from the scope of the present invention, management of the system may be provided with an interface to access statistical measures of the site operation such as: how much money is generated via each fundraising page, the entire website, daily transactions received by an active cause or member, number of new and total causes created, and new number of users that have created personal pages.

In another embodiment, a single server may be used to provide the profiles and payment/donation applications, record and keep track of any transactions, and host the website where users can register and create their personalized or cause pages. The term “cause user,” as utilized in this application, comprises any user of the network, including users that manage accounts, create accounts, own personal accounts, own cause accounts for fundraising purposes, and users that otherwise utilized a network for processing payments in accordance with the present invention.

The following is an exemplary use of a system in accord with one embodiment and is not intended to limit or deviate from the scope of the present invention.

For example, server 101 hosts an on-line community, such as profile in a Facebook™ platform, wherein a database within such platform stores user profiles for each member of that community. By injecting a payment or cause application into server 101's on-line community, or with the profiles in such Facebook™ platform, the application (each application associated with a cause information or personal information) may be virally distributed throughout the members in that community, including users each one of those members may be affiliated with, whether or not their affiliated parties belong to the on-line community hosted by server 101. Thus, making possible a distribution of such applications throughout network 100.

A member or user profiled in such Facebook™ platform, hosted by server 101, may ‘invite’ another interested party such as a non-affiliated user by logging on via user interface 104 and accessing his or her profile. Another user utilizing user interface 105 may come in contact with a profile accessed via user interface 104 and whether by ‘invite’ or simply browsing, come in contact with a payment or cause application in accordance with the present invention.

Since such applications can be shared between individual users (i.e. sharing a link or URL that allows users to be redirected to a desired page), user 104 can pass on to user 105 such applications. The payment and cause applications then redirect user 105 to server 102 and introduces that user to the hosted website where information on fundraising and other similar personal events are promoted. Thus, while each application gets distributed throughout network 100, more and more users are invited to the target website hosted by server 102.

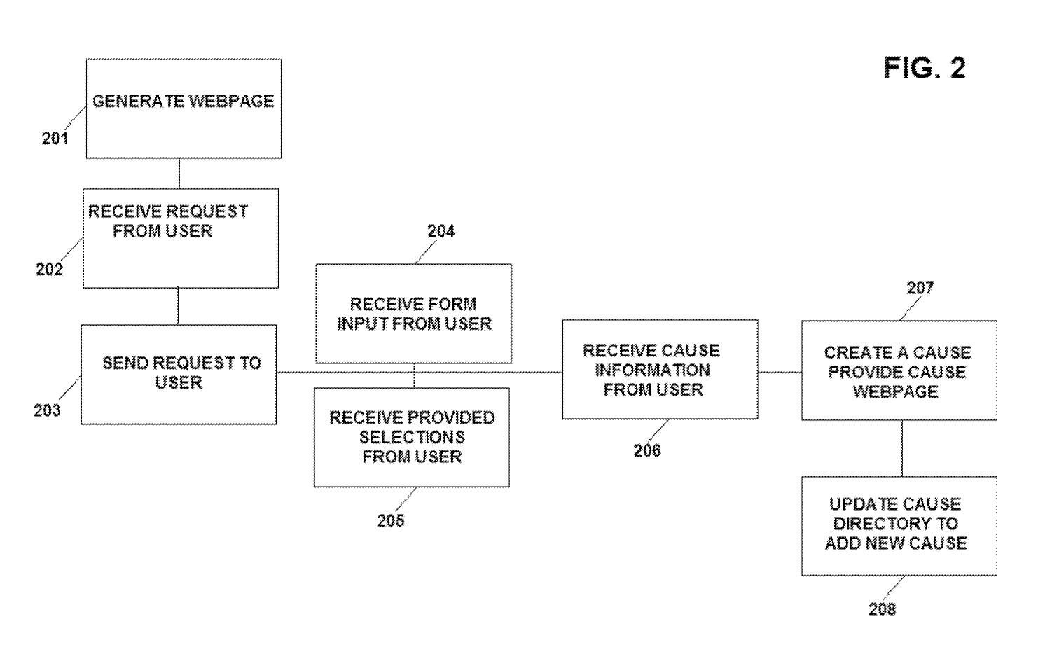

Next, some basic methods in accord with practice of the present invention are described and discussed. FIG. 2 is a flow chart depicting a basic method for generating a webpage and creating a cause page. The method is explained in the order shown below; however the following steps may be taken in any other conceivable sequence without deviating from the scope of the present invention.

At step 201, a webpage is generated to establish causes, fundraisers, or promote events.

At steps 202 and 203, a user request for a webpage is received and the requested webpage is sent to the user. The user may be provided with a fillable form, a set of pre-selected selections or options, or any other type of information gathering form to receive information pertaining to that user's cause along with personal information.

At steps 204 and 205 the user fills out the forms, or makes a selection, or otherwise provides the requested information regarding their cause and/or personal information. This information is received at step 206 and at step 207 the information is utilized to create and provide the user with their own personal or cause webpage.

Finally, at step 208, a cause directory is updated to add the newly created cause or personal page.

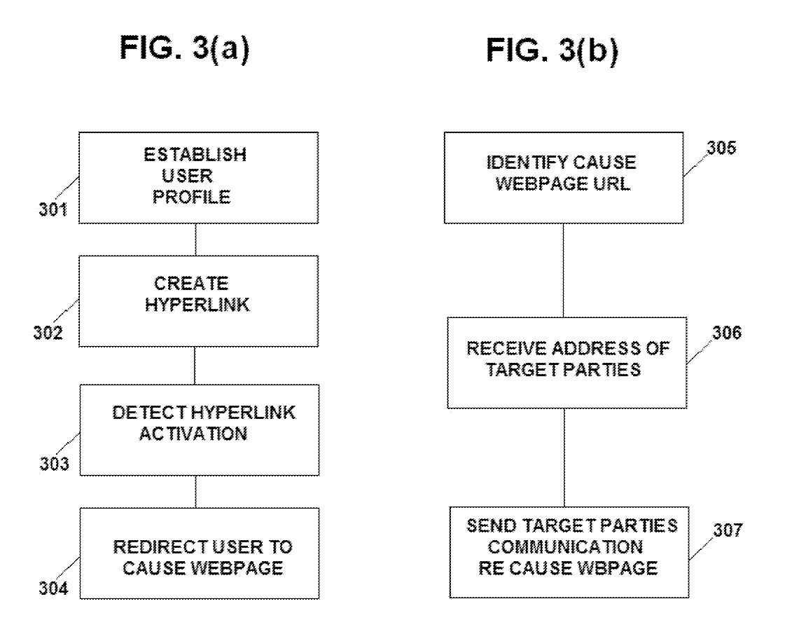

FIG. 3(a) is a flowchart depicting a basic passive method for promoting a cause related to an existing cause page or personal page, in accordance with practice of one embodiment of the present invention. The method is explained in the order shown below; however the following steps may be taken in any other conceivable sequence without deviating from the scope of the present invention.

At steps 301 and 302, a user profile webpage is established and a hyperlink created and provided for users. Users or members viewing a profile, such as a profile in a Facebook™ platform, may then click on the cause hyperlink if desiring to view the profiled member's cause or personal information posted in a website (external to the Facebook™ platform). At step 303 the hyperlink activation is detected and at step 304 the user is redirected to that profiled member's cause or personal webpage (located in a website outside the Facebook™ platform).

Turning to the next figure, FIG. 3(b) is a flowchart depicting a basic active method for promoting a cause, in accordance with the practice of one embodiment of the present invention. The method is explained in the order shown below; however the following steps may be taken in any other conceivable sequence without deviating from the scope of the present invention.

At step 305 a cause webpage URL is identified and at step 306 a user provides the addresses of targeted parties that may be interested in viewing the cause webpage. Finally, at step 307, the parties identified in step 306 are delivered an email communication with information regarding the cause.

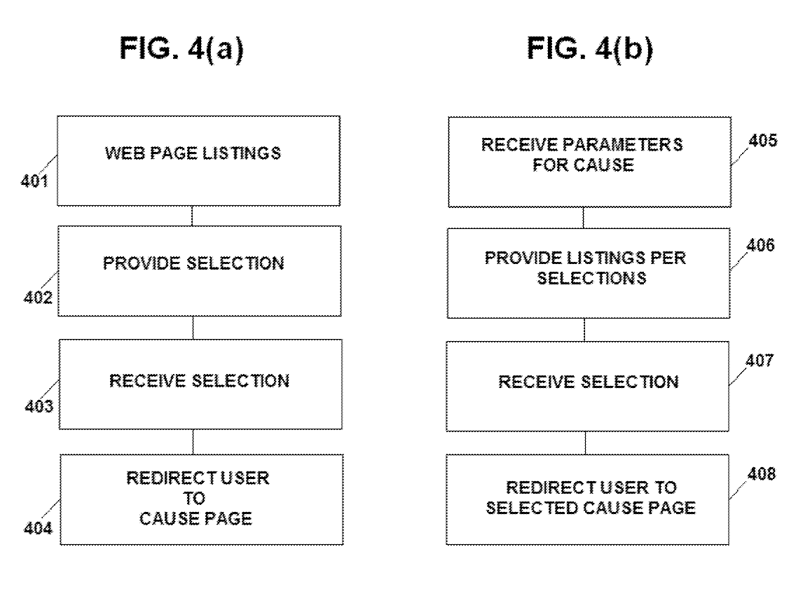

FIG. 4(a) is a flow chart depicting a basic method of generating a search for a cause page, in accordance with practice of one embodiment of the present invention. The method is explained in the order shown below; however the following steps may be taken in any other conceivable sequence without deviating from the scope of the present invention.

At step 401 a web page listing several causes (or their associated pages) which have been created by users is generated. A selection is provided at step 402 so that a user may pick which page to visit. After receiving a selection from an interested user at step 403, the user is naturally redirected to that selected cause page at step 404.

Another basic method to provide a search for a cause is illustrated by FIG. 4(b). At step 405 parameters for one or more causes are received from a user input. The search parameters may be in the form of a keyword search, a Boolean search, or any other search method known in the art. At step 406, a webpage is provided with a listing of causes based on the parameters received. The user may then select from the list a desired cause and upon receiving the selection from a user at step 407, the user is redirected to the selected cause webpage at step 408.

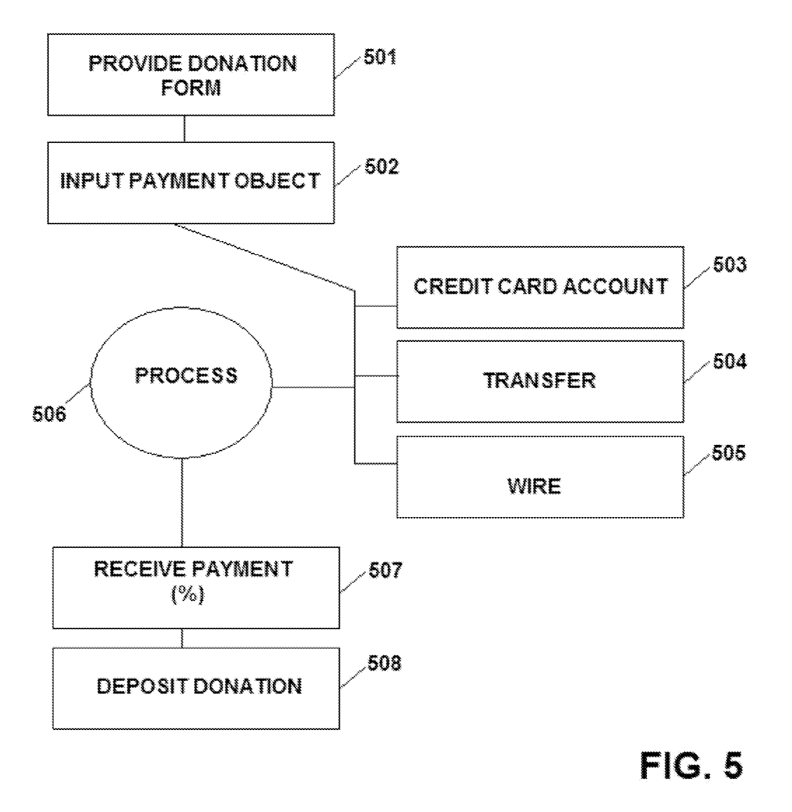

Next, FIG. 5 shows a flow chart depicting a basic method of receiving and processing a payment or donation, in accordance with one embodiment of the present invention. The method is explained in the order shown below; however the following steps may be taken in any other conceivable sequence without deviating from the scope of the present invention.

At step 501 the user is provided with a webpage with at least one input object wherein the user may input data such as a dollar amount that user desires to donate for a particular cause.

Once an input object is received from a user at step 502, the transaction may be completed either by requesting a credit card number at step 503, requesting an account number to transfer money from a pre-established account at step 504, or any information necessary to make a wire transfer at step 505. Naturally, this donation or payment may be made in any manner or combinations thereof, without deviating from the scope of the present invention. Once the required information is received, the transaction is processed at step 506.

At step 507, a percentage of the payment or donation is kept by the service provider and the remainder is deposited in the donation or payment destination account at step 508.

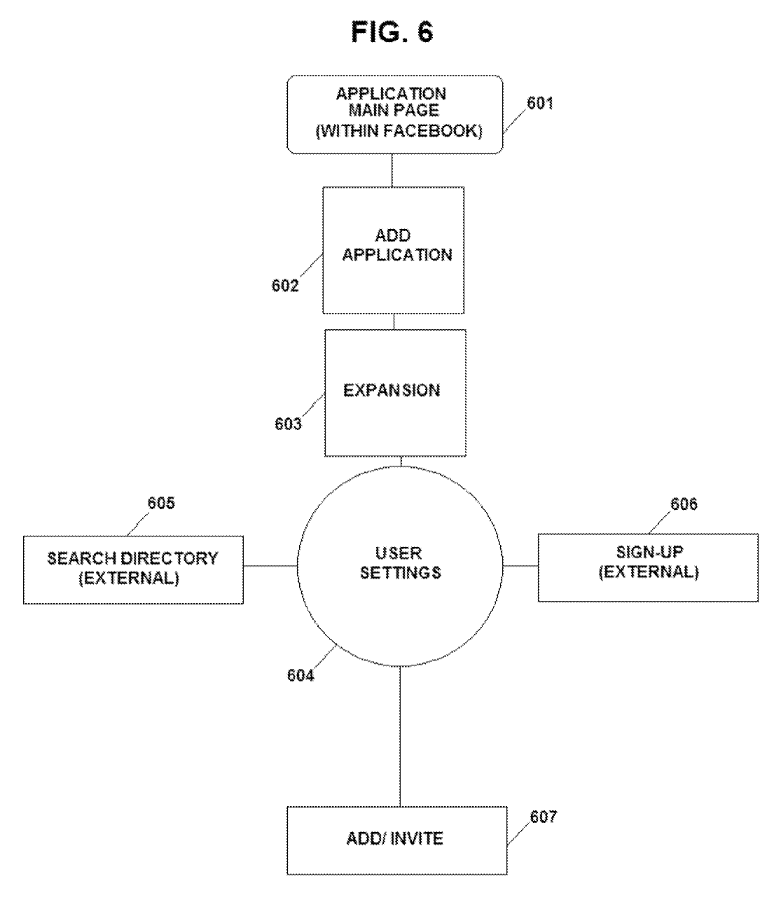

FIG. 6 illustrates a flow chart for a basic sign-up process of a user, such as a Facebook™ platform user, utilizing an application within the Facebook™ platform in accordance with one embodiment of the present invention. Facebook™ is a social networking site that allows a developer to submit an application on the Facebook™ platform. A Facebook™ user will be able to add the application for causes and fundraisers or personal payment in accordance with an exemplary embodiment of the present invention. The method is explained in the order shown below; however the following steps may be taken in any other conceivable sequence without deviating from the scope of the present invention.

Users sign-up to create an account in which they will receive funds for their desire purposes such as fundraising for a cause or for personal payments. For example, and without deviating from the scope of the present invention, users may sign-up as members to raise money for the homeless in their area, or request funds for a class trip to Europe. Either way and for whatever purpose, the sign-up process establishes their membership to the website and an account associated to their particular cause. Basically, at step 601, users are provided a Facebook™ platform profile web page, wherein they may search, create, or add causes (created by other members) to their profile. In this way, users may become members and create their own cause or donate to other users' causes once linked to an external website.

In an exemplary embodiment of the invention, the application main page (within the Facebook™ platform) at step 601, may include an “add application” button (or link), a description or screenshot sample of the payment application, a link that allows a user to view other Facebook™ friends that already have added the application, a discussion board, and a comments section. The application may also be located in the Facebook™ directory of applications.

In order to continue the sign-up process, a Facebook™ user may then add the application at step 602 by following the appropriate link, for example, an “add application” ‘button’ or link. In one embodiment, clicking on the add application provides a selection of options, or questions designed to collect information, that may help disburse the payment or cause application throughout the network.

Step 603 may also be taken to expand the application throughout the network. This step may provide users with a list of other members that the user may be affiliated with in some way. This feature invites the user to invite others to be notified of the cause and/or payment applications and to join as members as well. By pre-selecting a user's affiliated members and providing the user an opportunity to continue and invite others to the website, the application is virally disbursed or distributed throughout the network, for example an online community or the entire internet. In an exemplary embodiment, a user may send a “massive invite” to a number of affiliated or associated users.

Whether or not a user decides to invite other users to join, at step 604 the user may be offered to adjust or select his or her settings. In one embodiment, the user's settings page requests the user to input an ID number associated with a cause or personal page in order to either be redirected to their webpage or, if signing up for the first time (or creating a new page), then redirected to a link where they may create one in step 606.

In another embodiment, at step 605, the user is allowed to search for causes that he or she may be aware of by being redirected to a directory of active fundraisers and active causes currently being promoted in the website.

Finally at step 607, a Facebook™ user is provided the opportunity to add a user or invite a user to their own personal page or fundraising event they happen to be hosting on-line at the website (external to the Facebook™ platform). This feature not only promotes a user's interests but also helps to further target other Facebook™ users to come use the (external) website.

By way of example, without deviating or limiting the scope of the present invention, the sign-up process may offer new users a choice between creating a Personal account (representing the individual user) and a Cause Account (representing a group or organization promoting a specific cause). Once the user signs up, information may be collected such as contact information, a name for their cause or event that user is promoting, and a keyword input that user may wish to provide for others to be able to search for his or her promotion.

A user must specify how they will be receiving funds from other users. This may be achieved in a number of different ways without departing from the scope of the present invention.

In one embodiment, the user registers their checking account number for ACH transfers. In another embodiment, a trust account or credit account is utilized to collect funds and thereafter the appropriate percentage is disbursed to the user.

Once signed up, a user's account may be assigned a default website ID number associated with the user and his or her personal webpage (within the website) or cause page that user has created (within the website).

When all sign-up is completed, a user may be redirected to an edit account page and provided a number of options to customize and promote their account and to further the viral distribution process—such as (respectively) creating their own URL and being prompted to provide a list of email addresses to invite others to their page and ultimately the main website.

In an exemplary embodiment, once signed up, a user will have a URL for their page. The primary page may be a personal primary page, where the user promotes themselves throughout the network, or a primary cause page, where the user promotes a cause or event either directly hosted by that user or as a representative of a larger organization.

For example, and without deviating from the scope of the present invention, a user may create a page as a representative of the Red Cross, raising money for natural disaster victims. That user's primary page would be a primary cause page, possibly entitled by the name of the event. Similarly, personal primary pages may have the user's name as the heading of the page. These primary pages are the main descriptive pages where individuals and causes solicit donations.

Both types of primary pages may offer links to make payments or donations. In one embodiment, visitors are able to request a friendship relationship to this page, which may generate a request to the owner of the page to allow the requestor to be added to the owner's friend's list. Such allied users (or ‘friends’) may be displayed on the primary page for other visitors to see. Furthermore, primary pages may also be linked with profile pages, for example and without departing from the scope of the present invention, primary pages are linked to a profile page found in server 101 (FIG. 1). Finally, customization options, personal contact information, and a list or set of links to any and all events that user may be promoting can be made available as well.

Cause pages are somewhat more customizable than Personal pages. For example, and without deviating from the scope of the present invention, the Primary Cause page may include contact information for the cause (in addition to contact information for the user/representative); general information about the cause; updates related to that particular cause; news posts; automated news feeds; a Cause blog; a petition section (in case political issues are involved); an events sections promoting different events related to that particular cause; photo galleries; comments section; a donor section relating to information input from donors (such as comments); and a cause embed to allow sharing and distributing of information related to the cause.

In one embodiment of the invention, cause pages may allow visitors of the cause pages to notify other users of the existence of the page vis a vis imputing email addresses and importing email contact lists for notification.

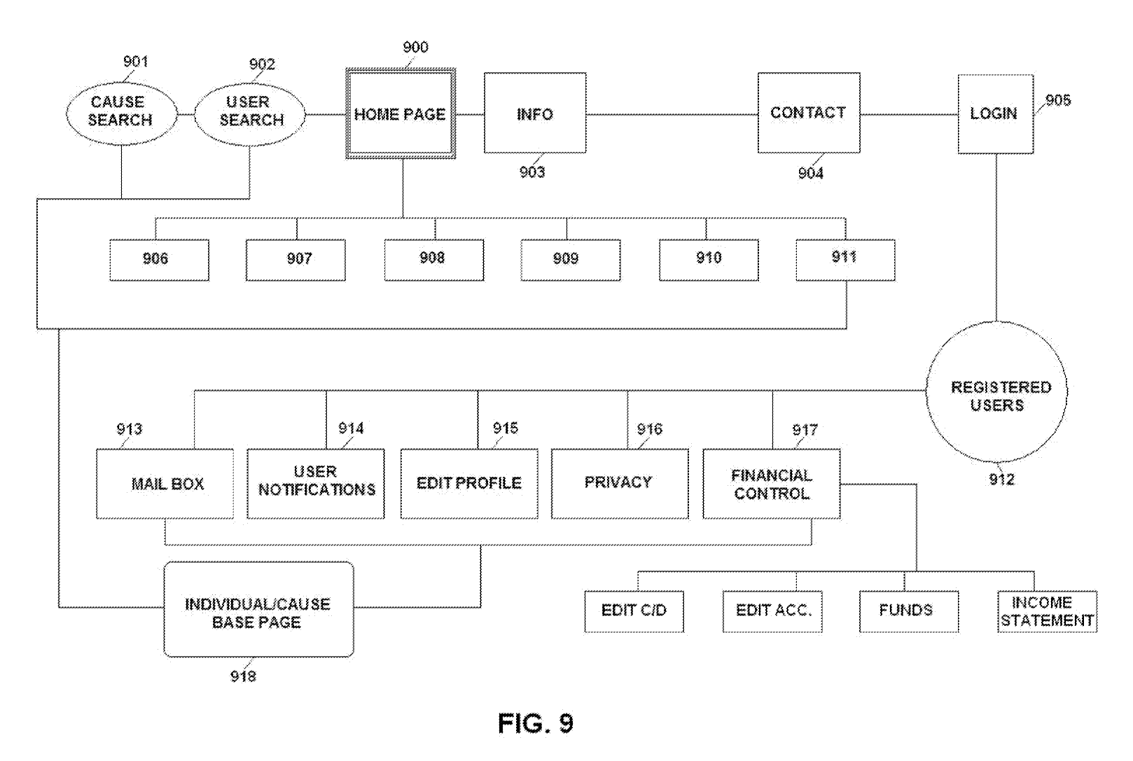

In an exemplary embodiment, three types of embeds may be created by clicking on a link provided in a ‘base page’ (see FIG. 9). These are meant to be chunks of code that can be copied and embedded, both by the user and others interested in a cause or event, into any webpage in a network (any webpage in the World Wide Web) as desired.

In another embodiment, both cause pages and personal pages may also allow visitors to spread notification by use of a graphical embed, which is displayed on these pages alongside their embed code. Upon imputing the embed code within the relevant portion of an external website (that allows code), the graphical embed is projected onto the page of the external website.

In yet another embodiment, embeds comprise of promotional information about the sub-section (for a cause), and links that allow the further notification of the sub-section, and overarching website.

For example, and without deviating from the scope of the present invention, promotional information may be composed of a name for the cause or person, a brief description of the cause, and a default picture representing the cause or person. The links on the embed may be composed of a link navigating a user to view the full page for the sub-section, a link navigating a user to donate money to the sub-section, a link navigating a user to a page where they can input email addresses and import their email contact lists to inform others of the site, and a link to the overarching site where they may create a sub-section of their own.

In an exemplary embodiment, each embed (whether associated to a user or a cause) includes a text at the top portion identifying the user or cause which is associated with the embed; a badge or embed associated with a user's or cause's logo or personal identification mark or photo; and a share button (which prompts users to obtain the code displayed) for linking the viewer to a page displaying the actual code of the embed so that users may “cut and paste” the embed into another webpage.

Again, these embeds may be utilized to link users to websites associated with a cause, to link users to a page where donations may be made, or any other function known in the art that may further advance the purpose of promoting information or creating fundraising opportunities.

Throughout the website and within the various pages (i.e. personal pages, cause pages, event pages, etc.) “invite” buttons or links may be placed to further promote users to utilize and visit the website. Such links may provide selection lists that include other user profiles and allows users to select which members (for example their friends) to invite. Such links may also be placed in profile pages.

The profile pages are the pages that exist for every personal member. Such pages may be located within the website. These pages may include a photo of the individual user, contact information, a list of all causes that user is allied with (or has joined), a list of friends, links to related pages, invite buttons, and any other features commonly used in the art as functionality options for user profiles.

Each profile will also include a link that would navigate to the person's primary page. Primary Personal pages include the person's name, a payment function, person's picture, a list of the person's allied causes and a link to view the person's profile, and any other personal details or representation of that person or their affiliation.

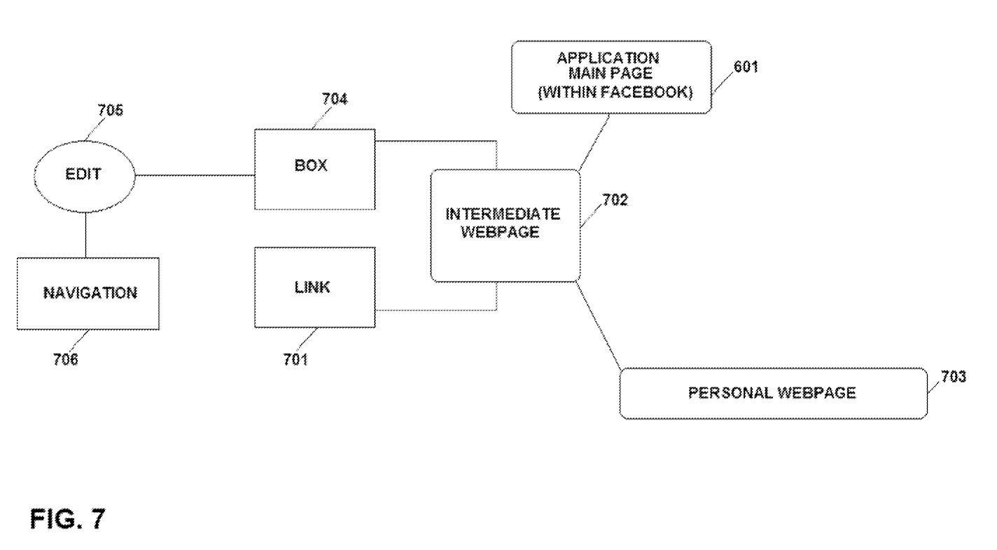

FIG. 7 is an organizational chart depicting the functionality and navigation of a Facebook™ platform user's profile utilizing a payment application within the Facebook™ platform in accordance with one embodiment of the present invention. Facebook™ is a social networking site that allows a developer to submit an application on the Facebook™ platform. A Facebook™ user will be able to add the application for causes and fundraisers or personal payment in accordance with an exemplary embodiment of the present invention. Once a Facebook™ user adds a causes and fundraisers or personal payment to his or her profile page, the user will be directed to invite friends in order to quickly spread the information about the user's causes or simply for allowing others to make payments to him directly for whatever reason.

As depicted in FIG. 7, Facebook™ personal profile pages utilizing a payment application in accordance with the present invention include a left hand navigation link 706, an edit box 705, an input box 704, and a transaction link 701. The payment application may link a Facebook™ user to an intermediate webpage 702, which is also within the Facebook™ platform, a personal webpage 703, and the application main page 601 (also located within the Facebook™ platform).

Transaction link 701 may be located anywhere on the personal profile page in the Facebook™ platform. In a preferred embodiment of the present invention, the transaction link 701 is conveniently located underneath a profile photo of the Facebook™ user. Transaction link 701 may also be labeled “Send Me Money” or “Send Money to David” in order to communicate to other Facebook™ visitors or users that the link is a function for making a monetary transaction to the specified person. Transaction link 701 links a Facebook™ visitor or user to an intermediate webpage 702 also within the Facebook™ site.

Intermediate webpage 702 provides a Facebook™ visitor or user with more information about the payment process and payments application. It serves as a safety precaution, asking the Facebook™ visitor or user to continue when ready if they desire to make the transaction. Additionally, intermediate webpage 702 allows the visiting user (viewing a member's profile) to add the payment application to their own profile. If the interested or visiting user decides to continue with the transaction, the user is redirected to the recipient's Primary Personal page, such as personal webpage 703.

Alternatively, if the Facebook™ visitor or user decides to add the payment application to their own Facebook™ personal profile, they are redirected application main page 601 within the website, where they begin the sign-up process described in FIG. 6.

Navigation link 706 will only be available for those users that have already added the payment application to their profile. Navigation link 706 allows a user to edit their settings in edit box 705, for example, setting which URL to set for their application in the event that user has multiple URL with multiple causes being promoted.

Input box 704 allows visiting Facebook™ users to fill in the amount desired to send to another user's personal or cause account. Input box 704 also has an add button to add the causes and fundraisers or personal payment application to a Facebook™ user's personal profile so that other Facebook™ users can donate money to their cause or make payments to them for whatever reason. Again, as with navigation link 706, if a user is viewing his or her own Facebook™ profile, they may edit their information through input box 704 as well.

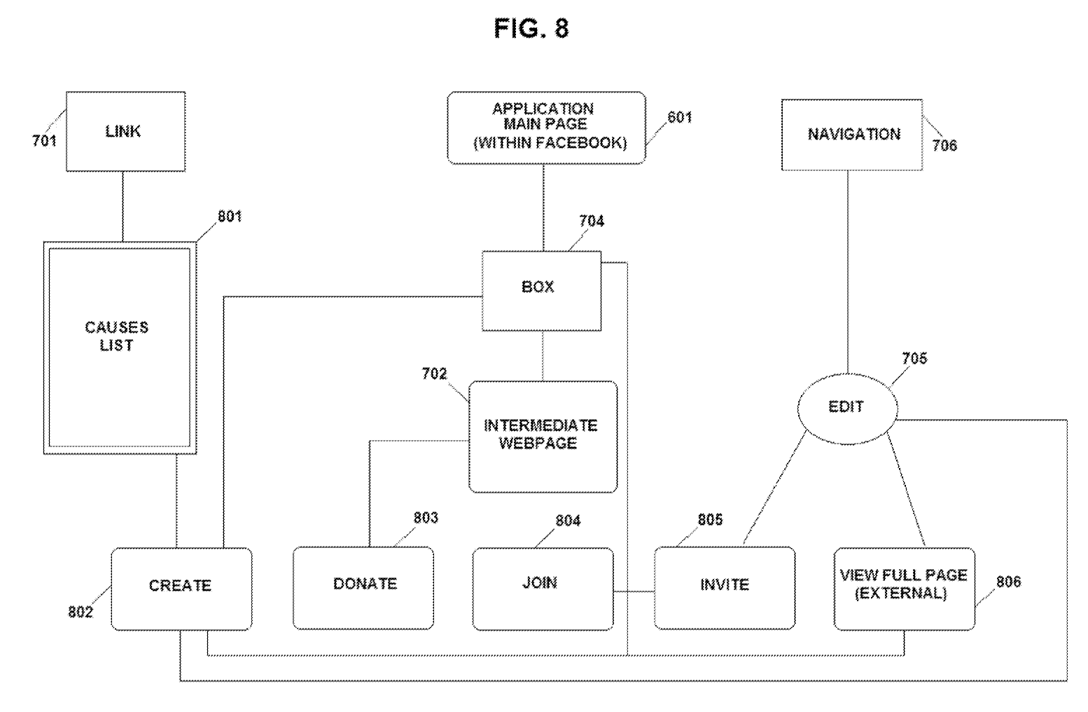

The functionality for the causes and fundraisers application in the Facebook™ platform is similar to personal payment application. FIG. 8 is an organizational chart depicting the functionality and navigation of a Facebook™ user's profile for a causes and fundraising application in accordance with another embodiment of the present invention.

FIG. 8 depicts Facebook™ users personal profile pages utilizing a cause or fundraising application in accordance with another embodiment of the invention which includes a navigation link 706, an edit box 705, an input box 704, and a transaction link 701. Like the payment, application, the cause and fundraisers application may link a user to an intermediate webpage 702, a personal webpage 703, and the application's main page 601.

Some subtle differences include titles on links that may be modified in a variety of ways without departing from the scope of the present invention. For example, transaction link 701 may read “View this Cause” or “Help the Homeless” rather than “Send Me Money,” depending on the type and kind of cause being promoted. In one embodiment, instead of directly requesting an input to send money, the link may take a user to view details of the causes created by the profiled user,

In addition to the functions provided by the payment application, a causes and fundraisers application further comprises a list 801, a create button 802, a donation button 803, a join button 804, an invite button 805, and a navigation button 806 that allows a Facebook™ user to view an external causes and fundraisers webpage.

FIG. 9 is an organizational chart for a website where users can search for causes, post their own causes or events, set-up and manage their accounts, and post donations, in accordance with an exemplary embodiment of the present invention.

In an exemplary embodiment, homepage 900 comprises of several links designed to direct users and visitors into the site along desired channels. These links include cause search link 901, user search link 902, information link 903, contact link 904, log-in link 905, link 906, link 907, information links 908, 909 and 910, and a cause directory 911.

Link 906 may be a most popular pages section. These pages may be determined by the amount of traffic, the type of funding, their popularity or any other type of measure known in the art. This may also include a link, to each cause's primary page.

Link 907 may be entitled an “Up and Coming” page, dedicated to a listing of such pages. For example, those pages that have the largest absolute delta between their hits in the last 7 days compared to the previous 7 days. This listing may be in the same form as that for the most popular pages and will also be expandable.

Information links 908, 909, and 910, are there to provide information to users and visitors regarding the functionality of the site, information about how funds may be raised through the site, and other helpful informational links on the entire network, including a FAQ section.

Search link 901 and user search 902 may be utilized to search for causes or individuals who have posted primary pages These searches, as discussed in FIGS. 4(a) and 4(b), may be performed in different manners without deviating from the scope of the present invention. In such exemplary embodiment, the search bars or links 901 and 902 allow users to search by keywords that members have added on file which are associated to their causes or personal pages. Further, search links 901 and 902 may be linked to advanced search pages to allow for more refined searches.

Cause directory 911 may consist of a set of links, each of which will navigate the user to a page listing of causes associated with a particular topic. For example, and without departing from the scope of the present invention, some classifications may include politics. Campus Organizations, Entertainment, Environment, Family, Children, Social, Cultures and Communities, News and Journalism, Natural Disaster Relief, Court Rulings, Medicine/Health, Religion, Film and Television, Comedy, Music, Arts and literature, and Sports.

Some of these may have additional sub-categories, such as Health may include Diseases, Conditions, Projects, and Global Health.

In such exemplary embodiment, once a category is selected a user may receive a list of all the pages under that category which may also be further refined by performing an additional search. For example, The resulting list can be further refined using a keyword search, thus generating a shorter listing. These results can then be sorted by: Name, Date of creation, Number of allies, Number of views.

Login box 905 is for use by current members. This takes users to a registered users section 912 of the website. In such exemplary embodiment certain functionalities may be available for those members that are logged in. Including a mailbox 913, user notification 914, profile edit link 915, privacy options link 916, and financial control panel 917.

Mailbox 913 may be available to members that are logged in. Mailbox 913 provides users an interface that provides both an inbox and an outbox. From the outbox, users will be able to see if their outbound messages have been read and/or replied to yet.

In one embodiment, users may send money directly from the mail interface to other users. In another embodiment, selecting this option will bring up an interface for attaching a message to the donation. In yet another embodiment, the user can type in these messages, or they can select from several “canned” messages such as, “Happy Birthday”, or “Happy Graduation.”

The website also includes a search bar that allows users to search by keyword (associated keywords are provided by causes and can be managed from the cause's base page). In one embodiment, this bar links to a set of advanced search pages, which allow users to conduct more refined searches. There may be one advanced search page for causes, one for individuals, and one for events.

In an exemplary embodiment, searches for causes are performed by keyword and the results will list: cause name, cause photo, date of creation, parent cause or sub-cause if relevant number of allies, number of page views, URL. Cause searches may be sorted in both ascending or descending order on the following criteria; name, date of creation, number of allies, number of page views. Personal searches may be matched by name or by email address and the results will list: photo, name, age, and location. Users can narrow personal search results by any of the following: Location (i.e. by mile radius from an entered zip code to the provided address of the individual), last name, first name, age. Event searches are matched on any of the following criteria: Location (as specified by a mile radius from a specified zip code to the provided location), Keyword, or date of event.

Base pages 918 exist for both types of accounts—personal and cause accounts. Base pages allow users to receive updates from other users, edit how featured pages are viewed, how money is received, and links to control various other preferences such as a link to an embed creation page—a page where chunks of code are created that can be copied and embedded, both by users and interested parties, into other desired web pages throughout the internet.

In one embodiment, the updates section includes updates received from the user's “allied causes.” Individuals who are associated with a particular cause are referred to as allies. These sections of the base page (one for each cause to which the individual or cause is allied) will display recently updated bulletins, events, and news related to the specific cause.

In another embodiment, a notifications, such as user notification 914, may include features such as: New Messages (from other users); New Comments (posted to the user or cause from someone viewing their information page); and New ‘Alliance Requests’ to allow users to manage their allies and to approve or deny new alliance requests.

Additionally, user notifications 914 may also include: New Event Invites, New Friend Requests, and “New Money Received” notification when new donations have arrived since the last time a user has logged in.

In another embodiment, financial control section 917 may also include an income statement section. This section may provide a brief overview of all funds currently being held (i.e. not yet deposited into a bank account). For example, and without deviating from the scope of the present invention, this overview can be expanded to provide a detailed list of all transactions that have not yet been resolved or deposited. Users may also navigate from this section to an “income details page” that will allow the user to list transactions by a selectable date range, thus allowing for financial reporting and tracking on transactions that have already been resolved.

Under financial control section 917, users may have the ability to deposit funds to their bank accounts, or to transfer funds to another user from an “income details page” if they have provided the necessary bank routing information. Users may also select the option to direct deposit funds into their bank account, rather than to manage them manually. For example, and without departing from the scope of the present invention, the current balance may always read “Direct Deposit” rather than stating a balance. It may be desirable however, that reporting should show total donations for the selected date range. In the event a cause user has multiple sub-causes, the report may be organized in such a way as to allow the user to select which cause or sub-cause is being displayed. In one embodiment, an additional section may also be displayed under section 917 which provides a statistical marking of page hits. In another embodiment, the donations button may be disabled every time the donations function is disabled for a cause account. This function may then automatically insert itself if the cause account subsequently enables donations at a later date.

Edit profile 915 and privacy section 916 are similarly available to users to edit their preferences. Editing privacy options may allow users to choose to display or hide their name, age, and location, and even block other users from communicating with another user or viewing another user's information. For example, and without departing from the scope of the present invention, an interface may allow individuals to be added or removed from a “blocked” list—a user will not receive mail, or alerts of any kind regarding anyone entered on their blocked list.

Other options that may be available to users through their base page include: editing user photos, editing or creating badges to personalize their web pages, editing credit card information, editing bank information, editing their “alliances,” editing assignments, and editing their keywords.

A system and method for a system and method for virally distributing fundraising payment applications has been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching. It is intended that the scope of the invention not be limited by this detailed description, but by the claims and the equivalents to the claims.

What is claimed is:

1. A method of creating a cause, comprising:
generating a webpage for establishing a cause;
receiving a request from a user for said webpage;
sending said webpage to said user, wherein said webpage includes an input object for receiving information related to said cause;
receiving said cause information from said user;
adding at least a portion of said cause information to said webpage; and
updating a cause directory to add said cause webpage.

2. The method of claim 1, wherein said input object is a fillable form for receiving information regarding said cause.

3. The method of claim 1, wherein said input object includes a list of predetermined information regarding said cause.

4. The method of claim 1, wherein said cause is related to a fundraising activity.

5. The method of claim 1, wherein said webpage pertains to a personal account of said user.

6. The method of claim 5, further comprising creating a personal profile for said user.

7. The method of claim 1, wherein said user is affiliated with an organization for promoting said cause.

8. The method of claim 1, wherein said cause information comprises a title for said cause and one or more meta tags related to said cause.

9. The method of claim 1, wherein said cause information comprises information related to an account to receive funds for said cause.

10. The method of claim 1, further comprising assigning a URL for said webpage.

11. A method of promoting a cause, comprising:
establishing a user profile webpage including a hyperlink pointing to a cause webpage related to said cause;
detecting an activation of said hyperlink; and
sending said cause webpage to said user in response to detecting said activation of said hyperlink.

12. The method of claim 11, further comprising creating said cause webpage that includes an embed associated with said cause.

13. The method of claim 11, further comprising sending said cause webpage in response to detecting said activation of said hyperlink.

14. A method of promoting a cause, comprising:
receiving information identifying a cause webpage;
receiving information related to an address of a target party; and
sending a notification to said target party regarding said cause webpage.

15. The method of claim 14, wherein said information identifying said cause webpage comprises a URL.

16. The method of claim 14, wherein said address information of said target party comprises an email address.

17. The method of claim 14, wherein sending said notification to said target party comprises sending an email to said target party.

18. The method of claim 14, wherein sending said notification to said target party comprises sending a text message to said target party.

19. The method of claim 14, wherein sending said notification to said target party comprises sending an audio message to said target party.

20. A method of searching for a cause, comprising:
creating a first webpage including a listing of causes;
receiving a selection of at least one of said cause from a user;
sending a second webpage related to said selected cause to said user.

21. The method of claim 20, wherein said first webpage contains a cause classification directory that includes a plurality of links to distinct webpages each including a listing of causes associated with a certain topic.

22. The method of claim 21, wherein said cause classification is selected from a group consisting of politics, campaigning, campus, entertainment, environment, family, children, social, cultural, News and journalism, disaster relief, judicial, health, religion, arts and literature, sports, diseases, conditions, projects, and global health.

23. A method of searching for a cause, comprising:
receiving one or more parameters related to one or more causes from a user,
creating a webpage with listing of one or more causes based on said one or more parameters, and
sending said webpage to said user.

24. The method of claim 23, further comprising:
receiving a request for a cause webpage related to a selected cause among said listing of one or more causes; and
sending said cause webpage to said user.

25. The method of claim 23, wherein said one or more parameters relates to a particular medical illness.

26. A method of receiving a donation for a cause comprising:
creating a cause donation webpage including a payment input object,
receiving a payment from a donor,
crediting a first account with a first portion of said payment,
crediting a second account with a second portion of said payment.

27. The method of claim 26, wherein said payment input object is adapted to receive credit card transaction payment.

28. The method of claim 27, wherein said credit card transaction payment is processed by an internet merchant account.

29. The method of claim 27, wherein said credit card transaction payment is processed by a payment gateway.

30. The method of claim 27, wherein said credit card transaction payment is processed by a secure certificate (SSL).

31. The method of claim 26, wherein said payment input object adapted to receive a wire transfer payment.

32. The method of claim 26, further comprising sending a prompt for a message to said donor.

33. The method of claim 32, wherein said message is selected from a plurality of previously posted messages.

34. The method of claim 26, wherein after receiving said payment from said donor, a notification is sent to a cause user managing said cause.

35. A method of linking a plurality of members of an external user profile server to a cause server comprising:
creating a profile on said external user profile server with a hyperlink to a cause webpage on said cause server;
receiving, by said cause server, a request for said cause webpage from a user;
sending, by said cause server, said cause webpage to said user.

36. The method of claim 35, further comprising raising funds and promoting events for said cause.

37. The method of claim 35, wherein said external user profile server is operated by Facebook™.

38. The method of claim 35, further comprising:
said cause server sending information related to a list of causes to said external user profile server; and
said external user profile server providing a webpage including said information related to said list of causes.

39. The method of claim 35, wherein information related to said list of causes comprises one or more of the following: a profile picture related to a cause, a brief description of said cause, a functional hyperlink to a cause webpage, and a functional hyperlink to a payment webpage related to said cause for donating to said cause.

40. The method of claim 39, wherein said functional hyperlink to said payment webpage is located below said profile picture on said webpage.

41. A system for creating, promoting, and receiving donations for a cause, comprising:
a first server comprising:
a cause creation module for:
generating a cause webpage for establishing a cause;
receiving a request from a user for said cause webpage;
sending said cause webpage to said user wherein said cause webpage includes an input object for receiving information regarding said cause;
receiving cause information from said user;
adding said cause information to said cause webpage; and
updating a cause directory to add a hyperlink to said cause webpage;
a cause promotion module for:
establishing a user profile web page including a cause hyperlink related to said cause;
receiving a request for said cause webpage from a user;
sending said cause webpage to said user;
a cause donation module for:
creating a cause donation webpage including a payment input object for receiving payment for said cause;
crediting a first account with a first portion of said payment;
crediting a second account with a second portion of said payment; and
a second server for creating a profile with a link to said cause webpage.

42. The system of claim 41, further comprising:
a cause search module for:
creating a webpage listing a plurality of causes;
receiving a selection of a cause; and
sending a cause webpage related to said selection to said user.

43. The system of claim 42, further comprising:
a cause search module for:
receiving parameters for one or more causes;
creating a webpage with listing of causes based on said parameters;
receiving a selected cause from said webpage; and
redirecting to said selected cause webpage.

44. A method for creating, promoting, and receiving donations for a cause, comprising:
generating a cause webpage for establishing a cause;
receiving a request from a first user for said cause webpage;
sending said cause webpage to said first user wherein said cause webpage includes an input object for receiving information regarding said cause;
receiving said cause information from said first user;
adding said cause information to said cause webpage; and
updating a cause directory to add a hyperlink to said cause webpage,
establishing a user profile web page including a cause hyperlink related to said cause;
receiving a request for said cause webpage from a second user;
sending said cause webpage to said second user;
creating a cause donation webpage including a payment input object for receiving payment for said cause;
crediting a first account with a first portion of said payment; and
crediting a second account with a second portion of said payment.

45. The method of claim 44, wherein said cause relates to said payment from said second user to said first user.
